(19) United States
(12) Patent Application Publication
(10) Pub. No.: US 2008/0308405 A1
(43) Pub. Date: Dec. 18, 2008

(54) Optical Fiber Photocatalytic Reactor And Process For The Decomposition Of Nitrogen Oxide Using Said Reactor

(76) Inventors: Yi Hui YU, Taipei City (TW); Jeffrey Chi Sheng WU, Taipei City (TW); Din Ping TSAI, Taipei City (TW); Hung Ji HUANG, Changhua City (TW); Tai Chi CHU, Kaohsiung City (TW); Tai Wei LAN, Taipei City (TW)

Correspondence Address: HOLLAND & KNIGHT LLP, 10 ST. JAMES AVENUE, 11th Floor, BOSTON, MA, 02116-3889, US

(21) Appl. No.: 11/948,112

(22) Filed: Nov. 30, 2007

(30) Foreign Application Priority Data
Jun. 14, 2007 (TW) 096121550

(51) Int. Cl. B01D 53/86; B01J 15/00; B01J 19/12

(52) U.S. Cl. 204/157.15; 422/211; 422/186.3

(57) ABSTRACT

An optical fiber photocatalytic reactor is provided. The reactor comprises a reaction zone and multiple fibers located in the reaction zone. The fiber comprises a photocatalyst that is coated onto its surface via a thermal hydrolysis method. The adhesion between the fiber and the photocatalyst thereon is strong, and thus, the delamination of the photocatalyst film on the fiber can be prevented. Moreover, the optical fiber photocatalytic reactor is useful for the decomposition of nitrogen oxide which is one of air's most harmful contaminants. The present invention exhibits a high conversion of nitrogen oxide.

### RELATED APPLICATION

This application claims priority to Taiwan Patent Application No. 096121550, filed on 14 Jun. 2007, the disclosure of which is incorporated herein by reference in its entirety.

### BACKGROUND OF THE INVENTION

1. Field of the Invention

The present invention relates to an optical fiber photocatalytic reactor and its uses. Particularly, the present invention relates to the use of the reactor for the decomposition of nitrogen oxides.

2. Descriptions of the Related Art

The extent of air pollution is typically evaluated by the amount of fluorides, sulfur dioxide, nitrogen oxides (NOₓ), carbon monoxide and ozone in the air quality. For example, nitrogen oxides, comprising NO and NO₂, are generally produced from the oxidization of N₂ in the air or nitrides in various fuels during combustion. The main source of nitrogen oxides comes from the exhaust of automobiles, motor cycles and industrial boilers.

During the 1960s in Los Angeles, Calif., U.S.A., the occurrence of photochemical smog arose due to a large amount of olefinic hydrocarbons and nitrogen oxides exhausted by numerous automobiles. These pollutant materials absorbed heat under the ultraviolet irradiation of the sun and thereby became chemically unstable, eventually resulting in severely toxic photochemical smog. Such toxic smog irritates the eyes and respiratory tracts, as well as induces a variety of respiratory diseases, and thus, poses as a health hazard for humans.

As a result, many researchers have actively studied the decomposition of nitrogen oxides in the past years, with an expectation to minimize the pollution of nitrogen oxides in the environment. However, since nitrogen oxides are not subject to decomposition by direct heat, current researchers are focusing on the decomposition of nitrogen oxides through the photocatalytic reaction. For example, the research of direct photocatalytic reaction reported in J. of Catalysis, vol. 237, 393-404, 2006, Jeffery C. S. Wu and Yu-Ting Cheng found that, in the presence of a TiO₂ photocatalyst, most NO molecules are decomposed by being oxidized into nitrates. However, this method has a low conversion rate. Moreover, since the used photocatalyst must be washed with water for regeneration, it cannot be used continuously. Consequently, this method is especially not suitable for decomposing boiler exhaust, which contains a higher content of nitrogen oxides.

In addition to the direct photocatalytic reaction described above, another reaction mechanism was proposed to remove nitrogen oxides through selective catalytic reduction (SCR) reactions. For example, as disclosed by Pio Forzatti in an article published in App. Catal. A: Gen. (vol. 222, 221-236, 2001), in the presence of the commercially available catalyst V₂O₅—WO₃(MoO₃)/TiO₂, a thermal-catalytic reaction occurs at a temperature ranges form 300 to 400° C. to decompose nitrogen oxides. A conversion of 75% can be obtained when NH₃ is used as reducing agent. In addition, an article authored by Roberts, K and Amiridis, M in Ind. Eng. Chem. Res. (vol. 36, 3528-3532, 1997) showed that a nitrogen oxide conversion of 55% can be obtained at 300° C. using C₃H₈ as reducing agent. Further, as disclosed by Headon, K and Zhang, D in Ind. Eng. Chem. Res. (vol. 36, 4595-4599, 1997), an optimum nitrogen oxide conversion of 33% can be obtained at 650° C. using CH₄ as reducing agent. Similarly, Breen, J et al reported in J. Phys. Chem. B (vol. 109, No. 11, 4805-4807, 2005) that a NO conversion of 100% can be obtained when H₂ is used as reducing agent at 300° C., while a NO conversion of 70% can be obtained when CO is used as reducing agent at 350° C. It can be seen from the above references that to decompose nitrogen oxides, most of these SCR reactions require a reaction temperature above 300° C., which evidently consumes a lot of energy.

In 1977, the concept of an optical fiber photocatalytic reactor was proposed first by Marinangeli, R. E. and Ollis, D. F. (AIChE., vol. 23, 415-426, 1977). Briefly speaking, in an optical fiber photocatalytic reactor, optical fibers are provided with a photocatalyst material adhered on the surfaces thereof. The reactants to be decomposed are introduced into the reactor. When the light is propagating along the optical fibers, the photocatalyst on the fiber surface can effectively absorb light so that the reactants will undergo a desired photocatalytic reaction. An optical fiber reactor comprising optical fibers coated with TiO₂ is disclosed in U.S. Pat. No. 5,875,384 and U.S. Pat. No. 5,919,422. According to the two patents, the optical fibers are first impregnated into a suspension of TiO₂ particles and then taken out to undergo a drying and heat treatment process, thus, obtaining the TiO₂ coated optical fibers. Then, using light emitting diodes (LEDs) or other lighting devices as the light source, the optical fibers can be utilized to practice a photocatalytic reaction. Additionally, relevant articles describing optical fibers coated with photocatalyst are also published in the following references: Chemosphere, vol. 50, 999-1006, 2003, by Wang and Ku; Applied Catalysis B: Environmental, vol. 52, 213-223, 2004, by Danion et al; Environmental Science and Technology, 28, 670-674, 1994, by Hofstadler et al; and Environmental Science and Technology, 29, 2974-2981, 1995, by Peilland and Hoffmann.

The photocatalyst, used in the aforesaid optical fiber photocatalytic reactors, is usually the commercially available TiO₂ (trade name: P25), such as that disclosed by Wang and Ku (Chemosphere, vol. 50, 999-1006, 2003), Hofstadler et al (Environmental Science and Technology, 28, 670-674, 1994) as well as Peilland and Hoffmann (Environmental Science and Technology, 29, 2974-2981, 1995). The TiO₂ is composed of about 70% anatase TiO₂ and 30% rutile TiO₂. However, these photocatalysts have a relatively large particle size, which promotes the recombination of electron and hole pairs, resulting in low photocatalytic reaction efficiency. Moreover, in most conventional technologies, photocatalysts are coated onto the optical fiber surface in the form of photocatalyst particle suspensions or by use of adhesives. Such adhesive means is poor and tends to be weak due to the exfoliation of the photocatalysts from the optical fibers. In addition, in the research reported by Danion et al (Applied Catalysis B: Environmental, vol. 52, 213-223, 2004) and Hofstadler et al (Enviro. Sci. Technol., 1994, 28, 670-674), the TiO₂ precursors were also selected for use, but were not subject to any thermal hydrolysis reaction treatment, resulting in an insufficient photocatalyst on the optical fibers after sintering.

Given the above, the subject invention provides an optical fiber photocatalytic reactor by applying a photocatalyst coating onto the optical fibers via a thermal hydrolysis method. The reactor is suitable for photocatalyzing the decomposition of nitrogen oxides at room temperature.

### SUMMARY OF THE INVENTION

One objective of the subject invention is to provide an optical fiber photocatalytic reactor which comprises a reaction zone and multiple optical fibers located in the reaction zone, wherein a photocatalyst coating is applied onto the surface of each said optical fiber using a thermal hydrolysis method.

Another objective of the subject invention is to provide a process for the decomposition of a nitrogen oxide, which is characterized in that the decomposition is carried out in the presence of light in the optical fiber photocatalytic reactor described above.

### BRIEF DESCRIPTION OF THE DRAWINGS

FIG. 1 is a schematic view of light propagation along an optical fiber coated with a photocatalyst;

FIG. 2 is a schematic view of an embodiment of an optical fiber photocatalytic reactor 200 in accordance with the subject invention;

FIG. 3 is a schematic plan view of an embodiment of an optical fiber shelf 231;

FIG. 4 depicts the result of Example 3 illustrating an NO reduction reaction in an embodiment of the photocatalytic reactor of the subject invention using CH₄ as the reducing agent;

FIG. 5 depicts the result of Example 4 illustrating an NO reduction reaction in an embodiment of the photocatalytic reactor of the subject invention using H₂ as the reducing agent; and

FIG. 6 depicts the result of Example 5 illustrating an NO reduction reaction using sun as the light source on Pt/TiO₂ catalyst.

### DESCRIPTION OF THE PREFERRED EMBODIMENT

Optical fibers suitable for use in the optical fiber photocatalytic reactor of the subject invention are substantially not limited to any particular optical fiber, and are typically made of inorganic oxides, which may be silicon dioxide (SiO₂) or doped SiO₂ such as metal-doped SiO₂. Such a metal can be selected from a group consisting of Ge, Na, Ca, Mg, Li, or combinations thereof. In accordance with one embodiment of the subject invention, quartz (SiO₂) optical fibers are used. In this case, suitable optical fibers can be commercially available in the market such as quartz optical fibers produced by E-TONE TECHNOLOGY CO., LTD, or quartz optical fibers produced by 3M Company with the trade name of Power-Core-FF-1.0-UMT or Power-Core-FF-600-UMT.

Optical fiber used in this invention has a photocatalyst coating on its surface via a thermal hydrolysis method. Suitable photocatalysts, such as (but are not limited to) TiO₂, ZnO, Fe₂O₃, or a combination thereof, are well known to those of ordinary skill in the art. In consideration of toxicity as well as the reducibility and oxidizability of the catalytic materials, TiO₂ is less harmful to humans and the environment, and thus, is preferred as the photocatalyst. Furthermore, the nano-sized anatase TiO₂ is most preferable in terms of photocatalytic performance. To improve the catalytic performance, the photocatalyst may further comprise a transition metal, such as Pt, Ag, Cu, Au, Fe, or a combination thereof. The most preferred photocatalyst is selected from a group consisting of Pt, Ag, and an alloy thereof. The amount of transition metal used depends on the type of the photocatalyst and the species of the transition metal. For example, in using the transition metal Pt and/or Ag and the photocatalyst TiO₂, the amount of the transition metal ranges approximately from 0.1 to 3 wt % based on the weight of the photocatalyst.

According to the subject invention, the photocatalyst is coated onto the surface of optical fibers via a thermal hydrolysis method. The method typically comprises the following three steps: dipping an optical fiber in a photocatalyst sol; taking out the coated optical fiber from the photocatalyst sol and drying it; and then sintering the photocatalyst-coated optical fiber. To provide a further description, an optical fiber coated with TiO₂ photocatalyst will be used as an example to illustrate the thermal hydrolysis method. The synthesis comprises the following steps:

dissolving a titanium (Ti) precursor and optional transition metal into a polar solvent to provide a photocatalyst sol;

dipping an optical fiber in the photocatalyst sol;

taking out the optical fiber from the photocatalyst sol and then drying it; and

sintering the photocatalyst-coated optical fiber for a period ranging from 2 hours to 5 hours, wherein the sintering temperature ranges from 500° C. to 700° C.

Here, the Ti precursor refers to the component that can form a TiO₂ photocatalyst through an appropriate reaction, and is typically selected from a group consisting of a titanium alkoxide, titanium tetrachloride, and a combination thereof. The titanium alkoxide can be selected from a group consisting of titanium tetrabutoxide, titanium tetrapropoxide, titanium tetraethanoxide, ethanoxide tetramethanoxide, and combinations thereof. Titanium tetrabutoxide is preferred.

According to the subject invention, the titanium precursor, in a proper amount, is dissolved into the polar solvent, heated to an appropriate temperature and kept for a period of time to become a photocatalyst sol. The polar solvent suitable for the subject invention includes water, alcohol, acetone, or a combination thereof. From the economic consideration, water is preferred. The polar solvent may further comprise an acidic material, such as nitric acid, to facilitate the control of the thermal hydrolysis and keep the sol away from its isoelectric point. In the case that the polar solvent comprises nitric acid, the volume ratio of the Ti precursor (e.g., titanium tetrabutoxide) to the aqueous nitric acid solution ranges approximately from 1:2 to 1:10, and preferably from 1:5 to 1:7. In regards to the optional transition metal, its species and amount are just as described above. In the case where titanium tetrabutoxide is used as the Ti precursor, a transition metal can be dissolved in a 0.1M aqueous nitric acid solution at a ratio of 1.0%. Then, titanium tetrabutoxide is slowly added to the solution. Upon complete dissolution of the titanium tetrabutoxide, the solution is heated to 80° C. and kept at this temperature for 8 hours to finally form the photocatalyst sol in a white colloid form.

Subsequently, optical fibers are dipped into the resulting photocatalyst sol for a period, which typically depends on the variety of factors, such as fiber length, photocatalyst type, and the concentration level of the photocatalyst in the sol. Generally, the optical fibers can be taken out once the surface thereof is coated with a sufficiently thick and uniform photocatalyst layer. The dipping-coating time can be readily determined by those of ordinary skill in the art.

Subsequent to the dipping-coating, the optical fibers are taken out of the photocatalyst sol and dried. The speed with which the optical fibers are taken out is controlled within a range from 5 to 50 mm/min, and preferably within a range from 20 to 40 mm/min. The drying is conducted at a temperature ranging from room temperature to 150° C. for 2 to 4 hours, to evaporate the polar solvent of the photocatalyst sol coated on the fiber surface.

Finally, the dried photocatalyst-coated optical fibers were subjected to a sintering process at a temperature ranging from 500° C. to 700° C. for 2 to 5 hours. Through this sintering process, the resulting TiO₂ photocatalyst becomes 100% anatase TiO₂ with an excellent photocatalytic performance. Also, the strong adhesion against exfoliation is achieved between the resulting TiO₂ photocatalyst and the optical fibers.

According to the subject invention, the surface of the bare optical fibers is treated with an alkaline solution before being subjected to the photocatalyst coating using a thermal hydrolysis method. The alkaline solution has a hydroxide ion concentration ranging from 0.5N to 10N, and preferably from 1N to 10N. For example, the optical fibers can be washed with a 5 N NaOH solution before being subjected to the photocatalyst coating. If commercially available optical fibers are used, such as quartz optical fibers produced by E-TONE TECHNOLOGY CO., LTD, the polymeric protection film that is wrapped around the optical fibers must be removed (e.g., a heat treatment process at a temperature ranging from 400° C. to 500° C. in air) before the alkaline solution wash and the subsequent dip-coating step.

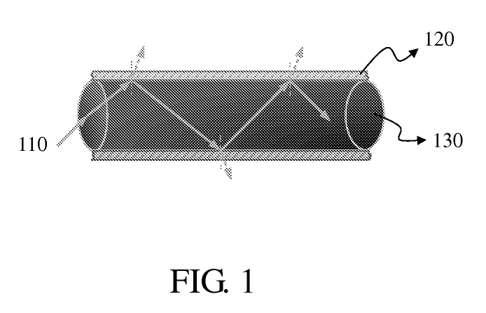

The optical fiber photocatalytic reactor of the subject invention is described with reference to accompanying figures. FIG. 1 schematically depicts the propagation of light within the optical fibers coated with a photocatalyst. When light 110 enters into an optical fiber 130 and impinges on the inner wall thereof, a portion of the light 110 will transmit through the inner wall of the optical fiber 130 and be absorbed by the photocatalyst coating 120 to induce a photocatalytic reaction. The rest of the light 110 is reflected off the inner wall and continues to propagate within the optical fiber 130 until it is completely absorbed by the photocatalyst coating 120. In this way, light propagating within the optical fibers is allowed to interact effectively with the photocatalyst to activate a photocatalytic reaction. As a result, light is effectively used, contrary to conventional photocatalytic reactors, where the light had to penetrate the reactants before reaching the photocatalyst (i.e., the applicability of light is affected by the light-penetration property of reactants).

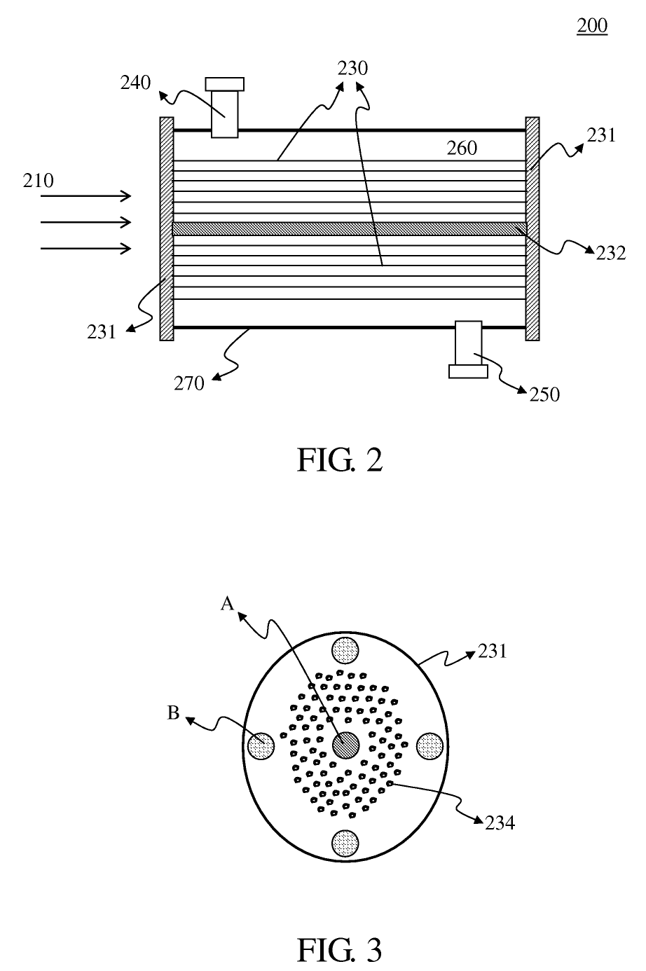

FIG. 2 is a schematic diagram of one embodiment of an optical fiber photocatalytic reaction 200 in accordance with the subject invention. The main architecture of the reactor 200 comprises a reaction container 270 having a reaction zone 260 and being made of a transparent material such as quartz glass, two optical fiber shelves 231, multiple optical fibers 230 located in the reaction zone 260, and a supporting rod 232. The function of optical fibers 230 are depicted in detail in FIG. 1; however, the photocatalyst coated onto the surface of optical fibers 230 by the thermal hydrolysis method is not shown in FIG.2. The optical fiber shelves 231 and the supporting rod 232 are typically made of stainless steel. The rod 232 is assembled to provide the space between two optical fiber shelves 231. In general, the supporting rod 232 supports the two optical fiber shelves 231 at the center. Additional supporting rods may be provided to reinforce the structural stability between the two shelves 231. FIG. 3 further illustrates a schematic diagram of one embodiment of the optical fiber shelf 231. Briefly speaking, the optical fiber shelf 231 has multiple holes for the optical fibers 230 to be inserted into and thus, be fixed in the reaction zone 260. The central location A of the optical fiber shelf 231 serves as a connection point to the supporting rod 232. Again, additional supporting rods may be connected through the perimeter locations B.

Referring again to FIG. 2, the container 270 has a gas inlet 240 to introduce gas into the reaction zone 260. After light 210 enters into the optical fibers 230 for the photocatalytic reaction in the reaction zone 260, the effluent will exit the reaction zone 260 through a gas outlet 250. Here, the sunlight or other appropriate artificial light sources may be employed to provide the light 210, which typically comprises light with an ultraviolet region. When the sunlight is used as the light source, the usual practice is to collect the sunlight with a sunlight collecting system and then introduce the concentrated sunlight into the reactor 200. In this case, the solar light activates the photocatalytic reaction, thus saving energy. In other cases, artificial light sources may be used, including LEDs, metal halide lamps, mercury lamps, halogen lamps, high pressure sodium lamps, arc lamps, and the likes.

Furthermore, to improve the control of the entire photocatalytic reaction, the optical fiber photocatalytic reactor 200 may be provided with a pressure gauge and a thermometer (neither is shown here) to monitor pressure variation and reaction temperature inside the reaction zone 260. Also, the optical fiber photocatalytic reactor 200 can be optionally wrapped with a material (e.g., aluminum foil) capable of blocking environmental light, so as to prevent any interaction between the photocatalytic reaction and environmental light.

In accordance with an embodiment of the subject invention, an optical fiber photocatalytic reactor of the subject invention is utilized to decompose nitrogen oxides (e.g., NO, NO₂, or a mixture thereof). In particular, an inert gas stream (e.g., He, Ar, or a combination thereof) is first introduced into the optical fiber photocatalystic reactor for a period of time to purge the impurities in the reactor. Subsequently, an incident light is sent into the optical fibers inside the reactor at room temperature, and then nitrogen oxide is introduced into the reactor to perform the photocatalytic reaction. The effluent is exhausted from the reactor, and the concentration of nitrogen oxides therein is measured to calculate the conversion.

The subject invention further provides a process for the decomposition of a nitrogen oxide, which is characterized by carrying out the decomposition in the presence of light in the optical fiber photocatalytic reactor. The steps involved in this process are just as described hereinbefore.

In accordance with another embodiment of the subject invention, a photocatalytic SCR reaction is carried out in the presence of a reducing agent to reduce a nitrogen oxide. Here, the reducing agent is selected from a group consisting of H₂, NH₃, CH₄, C₂H₆, C₂H₄, C₃H₈, C₄H₁₀, and combinations thereof. It is preferable for the reducing agent to be H₂, CH₄, or a combination thereof. In the case of using a reducing agent, the process of the subject invention comprises the following steps: passing an inert gas (e.g., He and/or Ar) into the optical-fiber photocatalytic reactor, introducing a reducing agent into the reactor so that the reducing agent is absorbed by the photocatalyst on the surface of the optical fibers. Subsequently, the nitrogen oxide is introduced into the reactor to perform a photocatalytic SCR reaction. The following examples illustrate that nitrogen oxide pollutants in the air can be effectively removed at room temperature by utilizing photocatalytic SRC reactions.

### EXAMPLE 1

### The Preparation of a Photocatalyst

In this example, the following three types of photocatalyst were prepared: TiO₂, α-Fe₂O₃, and ZnO. The TiO₂ photocatalyst was prepared by via a thermal hydrolysis method, illustrated in the following steps. First, metal Pt was dissolved in advance in a 0.1 M aqueous nitric acid solution at a ratio of 1.0%, to which 17 mL titanium tetrabutoxide was slowly added. Upon completion of the addition of the titanium tetrabutoxide, the solution was heated to 80° C. and maintained at this temperature for 8 hours. The white colloid was dried in an oven at 80° C. for 24 hours. The resulting white solid material was calcined in a furnace at 500° C. Regarding the ZnO photocatalyst, commercially available powder was directly adopted. On the other hand, the α-Fe₂O₃ photocatalyst was synthesized via sol-gel method. In particular, isopropanol and iron nitrate (20 mmol) reacted for 20 minutes to form an α-Fe₂O₃ precursor solution, to which a thickener polyethylene glycol (PEG) was added while stirring. The resulting precursor solution was placed in a high temperature furnace to be calcined at 700° C. for 10 minutes, and then cooled to room temperature. Finally, the calcined photocatalyst was milled into powder.

### EXAMPLE 2

### The Preparation of Optical Fibers Coated with a Photocatalyst

The preparation of the optical fibers coated with a photocatalyst was accomplished by adhering the white colloid obtained from Example 1 onto quartz optical fibers wherein the polymeric protection film had been removed from the surfaces. The method used was a dip coating process. Specifically, the optical fiber was thermally treated at 500° C. to remove the polymeric protection film on the surface, washed with an aqueous NaOH solution then alternately cleansed with water and dried. Next, the white colloid was placed in a container, and the optical fiber was dipped for 5 minutes. Thereafter, the optical fiber was pulled out with a speed of 3 cm/min, to obtain an optical fiber with a photocatalyst precursor adhered uniformly thereon. The resulting optical fiber was dried at 80° C. for 20 to 24 hours, and then was calcined at 500° C. to 700° C. in a furnace for 5 hours to become photocatalyst film on optical fiber.

### EXAMPLE 3

### Continuous Photocatalytic Reaction (with CH₄ as Reducing Agent)

Hundreds of optical fibers with a TiO2 photocatalyst coating thereon obtained in Example 2 were fixed inside the reactor on the stainless steel shelves. A He stream was introduced through the reactor with a flow rate of 20 ml/min for one hour to purge the impurities therein. Subsequently, a CH₄ stream with a 99% concentration level was introduced into the reactor under a flow rate of 60 ml/min for one hour, so that CH₄ was adsorbed onto the surface of the photocatalyst. Finally, a 50 ppm nitrogen oxide stream was introduced into the reactor with a residence time of 60 minutes, followed by a resumed CH₄ gas supply of a 99% concentration level with a residence time of 120 minutes. The light was transmitted into the reactor through optical fibers to activate the photocatalytic reaction using a metal halide lamp as the light source. Exhaust gas from the reactor outlet was delivered to a nitrogen oxide analyzer for the analysis of its concentration.

Conversion of the photocatalytic reaction was calculated using the equation below:

Conversion=[(concentration_{Pre-illumination}−concentration_{Post-illumination})/concentration_{Pre-illumination}]×100%

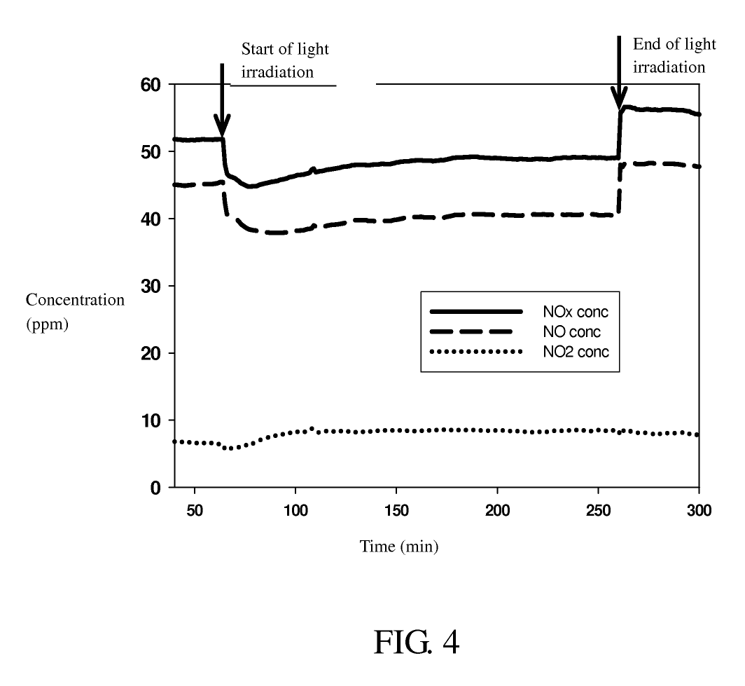

As depicted in FIG. 4, the NO conversion was 16%.

### EXAMPLE 4

### Continuous Photocatalytic Reaction (with H₂ as a Reducing Agent)

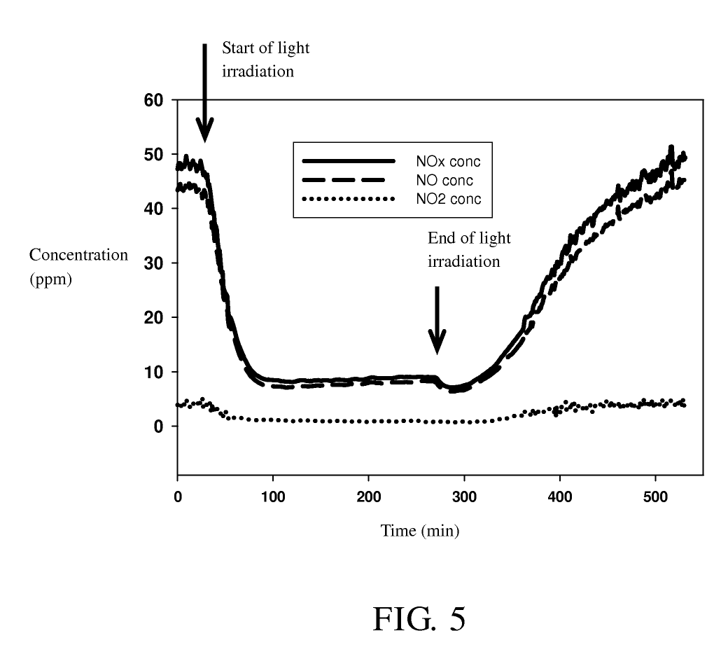

Materials and steps used here were the same as those in Example 3, except that H₂ was substituted for CH₄ as the reducing agent. As depicted in FIG. 5, the NO conversion was 83%.

### EXAMPLE 5

### Continuous Sunlight Photocatalytic Reaction

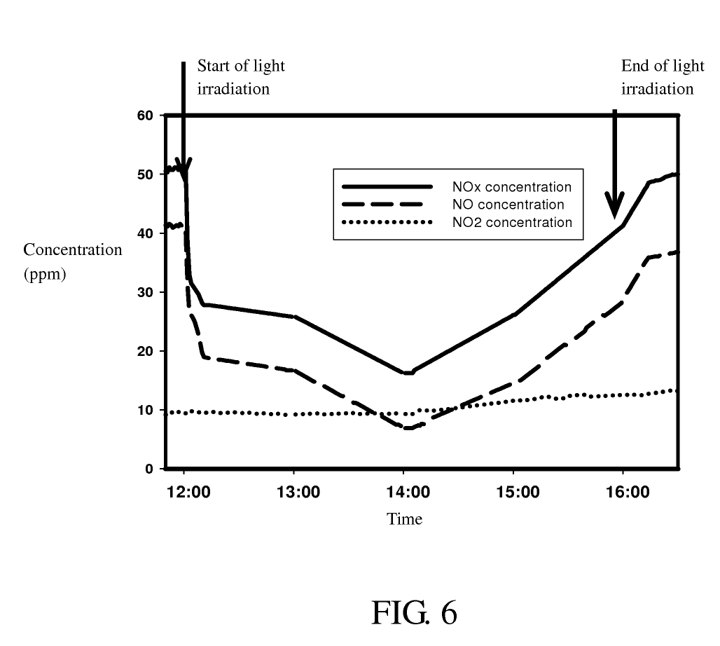

A sunlight collecting system was employed to collect sunlight for transmission to the reactor through optical fibers. Steps used here were the same as those in Example 3. A Pt/TiO₂ photocatalyst powder (0.2 g) was used to photocatalyze the reaction. As depicted in FIG. 6, the reaction conversion varies with sunlight intensity, with a maximum NO conversion of 83.2% at 2 pm. in the afternoon.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An optical fiber photocatalytic reactor, comprising:
a reaction zone; and
multiple optical fibers located in the reaction zone, wherein a photocatalyst coating is applied onto the surface of each the said optical fiber by a thermal hydrolysis method.

2. The reactor of claim 1, which is used for the decomposition of a nitrogen oxide.

3. The reactor of claim 1, wherein the nitrogen oxide is selected from a group consisting of NO, NO₂, and a combination thereof.

4. The reactor of claim 1, wherein the photocatalyst coating comprises a photocatalyst selected from a group consisting of TiO₂, ZnO, Fe₂O₃, and combinations thereof.

5. The reactor of claim 4, wherein the photocatalyst is anatase TiO₂.

6. The reactor of claim 4, wherein the photocatalyst coating further comprises a transition metal.

7. The reactor of claim 6, wherein the transition metal is selected from a group consisting of platinum, silver, copper, gold, iron, and combinations thereof.

8. The reactor of claim 1, wherein the surface of the optical fibers is treated with an alkaline solution prior to being applied with the photocatalyst coating, said alkaline solution has a hydroxide ion concentration of 0.5N to 10N.

9. The reactor of claim 8, wherein the alkaline solution has a hydroxide ion concentration of 1N to 10N.

10. The reactor of claim 4, wherein the photocatalyst is TiO₂ and the photocatalyst coated optical fiber is prepared by the steps of:
dissolving a titanium precursor and an optional transition metal in a polar solvent to provide a photocatalyst sol;
dipping an optical fiber in the photocatalyst sol;
pulling out the optical fiber from the photocatalyst sol and then drying it;
sintering the dried optical fiber for a period ranging from 2 hours to 5 hours, wherein the sintering temperature ranges from 500° C. to 700° C.

11. The reactor of claim 10, wherein the titanium precursor is selected from a group consisting of a titanium alkoxide, titanium tetrachloride, and combinations thereof.

12. The reactor of claim 11, wherein the titanium alkoxide is selected from a group consisting of titanium tetrabutoxide, titanium tetrapropoxide, titanium tetraethanoxide, ethanoxide tetramethanoxide, and combinations thereof.

13. The reactor of claim 12, wherein the polar solvent is selected from a group consisting of water, alcohols, acetone, and combinations thereof.

14. The reactor of claim 13, wherein the titanium precursor is a titanium alkoxide and the polar solvent is water.

15. The reactor of claim 1, further comprising a light source.

16. The reactor of claim 15, wherein the light source emits light with a UV wavelength.

17. A process for the decomposition of a nitrogen oxide, which is characterized in that the decomposition is carried out in the presence of light in the optical fiber photocatalytic reactor of claim 1.

18. The process of claim 17, wherein the nitrogen oxide is selected from a group consisting of NO, NO₂, and a combination thereof.

19. The process of claim 17, wherein a reducing agent is present in the reaction zone.

20. The process of claim 19, wherein the reducing agent is selected from a group consisting of H₂, NH₃, CH₄, C₂H₆, C₂H₄, C₃H₈, C₄H₁₀, and combinations thereof.
